(19) United States
(12) Patent Application Publication
(10) Pub. No.: US 2016/0154454 A1
(43) Pub. Date: Jun. 2, 2016

(54) STORAGE APPARATUS, STORAGE SYSTEM, STORAGE APPARATUS CONTROLLING METHOD

(71) Applicant: MEDIATEK INC., Hsin-Chu (TW)

(72) Inventor: Li-Chun Tu, Hsinchu City (TW)

(73) Assignee: MEDIATEK INC., Hsin-Chu (TW)

(21) Appl. No.: 14/905,971

(22) PCT Filed: Jun. 5, 2015
(86) PCT No.: PCT/CN2015/080891

§ 371 Date: Jan. 19, 2016

Related U.S. Application Data
(60) Provisional application No. 62/008,091, filed on Jun. 5, 2014.
(60) Provisional application No. 62/035,623, filed on Aug. 11, 2014.

(51) Int. Cl. G06F 1/32; G06F 9/44

(52) U.S. Cl. CPC G06F 1/3296; G06F 9/4418

(57) ABSTRACT

A storage apparatus, which is configured to receive an enter instruction to enter a deep sleep mode and configured to receive an awaking instruction to exit the deep sleep mode and to enter a normal mode. The storage apparatus keeps data stored therein in the deep sleep mode, and the storage apparatus can be normally accessed in the normal mode. If the storage apparatus is controlled to enter the normal mode while in the deep sleep mode, the storage apparatus enters the normal mode after the storage apparatus exits the deep sleep mode for a recovery time interval.

### CROSS REFERENCE TO RELATED APPLICATIONS

This application claims the benefit of U.S. Provisional Application No. 62/008,091, filed on Jun. 5, 2014 and U.S. Provisional Application No. 62/035,623, filed on Aug. 11, 2014. Also, this application is a continuation-in-part of applicant's earlier application, Ser. No. 14/139,951, filed Dec. 24, 2013 and is included herein by reference.

### TECHNICAL FIELD

The present disclosure relates to a storage apparatus, a storage system and a storage apparatus controlling method, and particularly relates to a storage apparatus, a storage system and a storage apparatus controlling method which can enter a deep sleep mode.

### BACKGROUND

A conventional storage apparatus typically has two operation modes: a normal mode and a standby mode. In the normal mode, data stored in the storage apparatus can be accessed (i.e. read or write). On the other hand, in the standby mode, data stored in the storage apparatus is kept but can't be accessed. If the storage apparatus exits the standby mode, the storage apparatus can immediately enter the normal mode.

However, in order to control the storage apparatus to immediately enter the normal mode after exits the standby mode, some devices in the storage apparatus must be kept active in the standby mode. Accordingly, the storage apparatus keep consuming power in the standby mode and may cause leakage currents due to the active devices.

### SUMMARY

One objective of the present disclosure is to provide a storage apparatus and a storage system that can suppress the power consumption and the leakage current.

Another objective of the present disclosure is to provide a storage apparatus controlling method and a storage system controlling method that can suppress the power consumption and the leakage current.

One implementation of the present disclosure provides a storage apparatus, which is configured to receive an enter instruction to enter a deep sleep mode and receive an awaking instruction to enter a normal mode after exiting the deep sleep mode. The storage apparatus keeps data stored therein in the deep sleep mode, and the storage apparatus can be normally accessed in the normal mode. If the storage apparatus is controlled to enter the normal mode while in the deep sleep mode, the storage apparatus enters the normal mode after the storage apparatus exits the deep sleep mode for a recovery time interval.

Another implementation of the present disclosure discloses a storage system, which comprises: a storage apparatus and a control apparatus configured to control a storage apparatus to enter a deep sleep mode via the control apparatus and configured to control the storage apparatus to enter a normal mode after exiting the deep sleep mode. The storage apparatus keeps data stored therein in the deep sleep mode and the storage apparatus can be normally accessed in the normal mode. If the storage apparatus is controlled to enter a normal mode in the deep sleep mode, the control apparatus controls the storage apparatus to enter the normal mode after the storage apparatus exits the deep sleep mode for a recovery time interval.

Storage apparatus controlling methods can be acquired in view of above-mentioned implementations. Detail steps thereof are omitted for brevity here.

In view of above-mentioned implementations, the storage apparatus can operate in a deep sleep mode that consumes less power and generates less leakage currents than a conventional standby mode. Further, methods for controlling the storage apparatus to the normal mode after exiting the deep sleep mode can ensure that the storage apparatus can be correctly accessed.

These and other objectives of the present invention will no doubt become obvious to those of ordinary skill in the art after reading the following detailed description of the embodiments that are illustrated in the various figures and drawings.

### BRIEF DESCRIPTION OF DRAWINGS

FIG. 1 is a block diagram illustrating a storage system according to one implementation of the present disclosure.

FIG. 2A is a block diagram illustrating detail structures for a storage system according to one implementation of the present disclosure.

FIG. 2B is a schematic diagram illustrating signal applied to the storage system depicted in FIG. 2A.

FIG. 3-5 are schematic diagrams illustrating methods for controlling the storage apparatus to exit the deep sleep mode and enter the normal mode according to one implementation of the present disclosure.

FIG. 6A and FIG. 6B are schematic diagrams illustrating the operation for separating the power up operation and the refresh operation, according to one implementation of the present disclosure.

### DETAILED DESCRIPTION

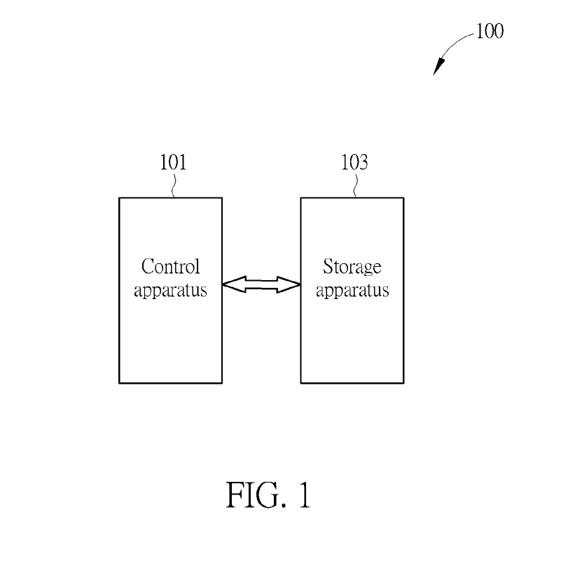

FIG. 1 is a block diagram illustrating a storage system according to one implementation of the present disclosure. As shown in FIG. 1, the storage system 100 comprises a control apparatus 101 and a storage apparatus 103. The control apparatus 101 controls the storage apparatus 103 to enter a deep sleep mode via an enter instruction. In such deep sleep mode, the storage apparatus keeps information already stored therein. Also, if the storage apparatus 103 is controlled to enter a normal mode while in the deep sleep mode via an awakening instruction from the control apparatus, the storage apparatus 103 enters the normal mode after the storage apparatus 103 exits the deep sleep mode for a recovery time interval. Fewer devices in such storage apparatus are active, since the storage apparatus does not immediately enter the normal mode after exists the deep sleep mode. By this way, less power consumption is needed and the above mentioned leakage current issue can be solved.

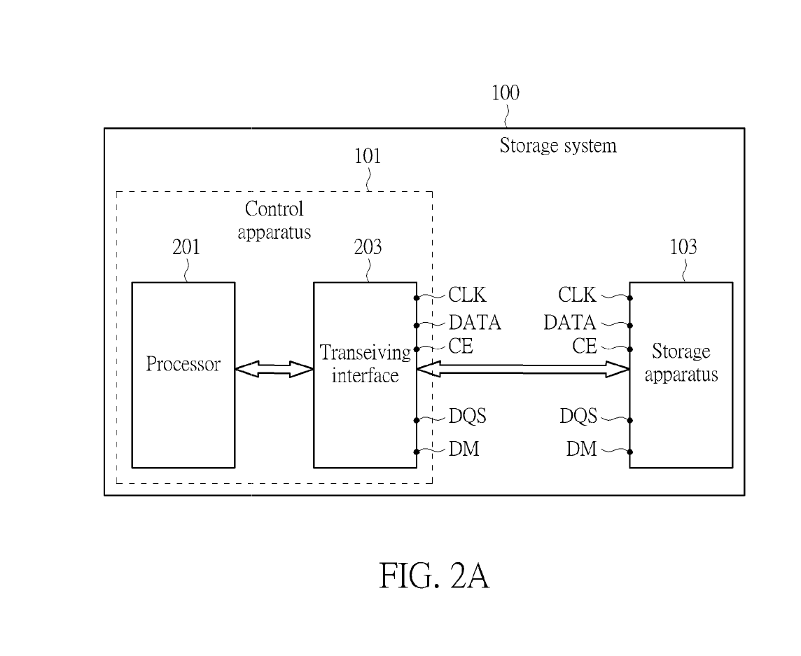

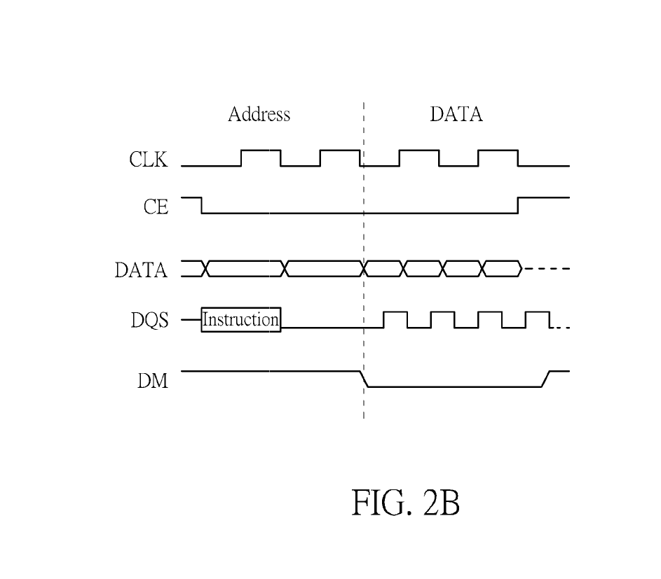

FIG. 2A is a block diagram illustrating detail structures for a storage system according to one implementation of the present disclosure. The structure of FIG. 2A has been disclosed in above-mentioned earlier U.S. application Ser. No. 14/139,951. The processor 201, transceiving interface 203 and the storage apparatus 103 in FIG. 2A of the present disclosure correspond to the processor 102, the media peripheral interface 106 and the peripheral device 104 in FIG. 1 of the earlier U.S. application Ser. No. 14/139,951.

As illustrated in FIG. 2A, the control apparatus 101 comprises a processor 201 and a transceiving interface 203. The transceiving interface 203 may be implemented as a hardware module and is coupled between the processor 201 and the storage apparatus 103 for communication therebetween. In some exemplary implementations, the processor 201, the storage apparatus 103 and the transceiving interface 203 are enclosed in a single module (or a package) as a system-in-package (but not limited thereto). The storage apparatus 103 may be a PSRAM, a FLASH memory, and so on. In addition to implementing a PSRAM interface or a FLASH interface, the transceiving interface 203 can be any interface matching the storage apparatus.

As shown in FIG. 2A, the storage apparatus 103 and the transceiving interface 203 respectively comprise a clock port CLK, a plurality of data ports (labeled DATA), a data strobe port DQS, and a data mask signal port DM. FIG. 2B is a schematic diagram illustrating a write operation for the storage system 100, please refer to FIG. 2A and FIG. 2B together to understand the present disclosure for more clear.

The clock port CLK is operative to transfer a clock signal (also designated as CLK) to the storage apparatus 103. The data ports (DATA) are provided for command transfer to the storage apparatus 103 and for data transfer to and from the storage apparatus 103. The data strobe port DQS is operative to transfer a data strobe signal (also designated as DQS) to or from the storage apparatus 103 according to an instruction that the processor 201 issues to the storage apparatus 103. For example, a data strobe signal DQS is transferred ‘to’ the storage apparatus 103 when a ‘write’ instruction is issued by processor 201, and, a data strobe signal DQS is transferred ‘from’ the storage apparatus 103 when a ‘read’ instruction is issued by the processor 201. The data mask signal port DM is optional (e.g., depending on the bit number of the data ports DATA), and operative to transfer a data mask signal (also designated as DM) to the storage apparatus 103 to mask particular transition edges of the data strobe signal DQS accordingly.

According to the clock signal CLK, the command information transferred via the data ports DATA is captured. As data transferred via the data ports DATA, it is captured according to rising edges and falling edges of the data strobe signal DQS when the data mask signal DM is disabled. When the data mask signal DM is enabled, the data transferred via the data ports Data is captured according to only particular transition edges (e.g. only H→L transition edges, or, only L→H transition edges) of the data strobe signal DQS. Note that the clock port CLK is not limited to providing a single connection terminal. In some implementations, the clock port CLK may provide a differential pair and the clock signal CLK may be a differential signal. Further, note that the data strobe port DQS is not limited to providing a single connection terminal. In some implementations, the data strobe port DQS may provide a differential pair and the data strobe signal DQS may be a differential signal.

The transceiving interface 203 and the storage apparatus 103 can further respectively comprise an access indicating port CE for an access indicating signal (also designated as CE), which indicates at least one accessing operation will be applied to the storage apparatus 103. Such access indicating signal CE comprises a first logic value (high logic value in this implementation) and a second logic value (low logic value in this implementation). If the access indicating signal CE transits from the first logic value to the second logic value, it means at least one accessing operation will be performed to the storage apparatus 103. Please note, such access indicating signal CE is optional.

Please note, FIG. 2B is a schematic diagram illustrating a write operation for the storage system 100, and the detail descriptions thereof are disclosed in the earlier U.S. application Ser No. 14/139,951. Additionally, other detail descriptions for the storage system 100 in FIG. 2A are disclosed in the earlier U.S. application Ser. No. 14/139,951, thus it is omitted for brevity here. Please note the storage system in FIG. 2A is only an example for explaining. The concept of the present disclosure is not limited to be applied to the storage system in FIG. 2A.

Please refer to FIG. 1 again. As above-mentioned, the storage apparatus 103 can be controlled by the control apparatus 101 to enter the deep sleep mode. Also, the storage apparatus 103 can be controlled by the control apparatus 101 to exit the deep sleep mode and enters the normal mode. However, the command for triggering the accessing operation may be wrongly received by the storage apparatus in the deep sleep mode or in the recovery time interval. Therefore, the present disclosure also provides other methods for controlling the storage apparatus to exit the deep sleep mode and to enter the normal mode.

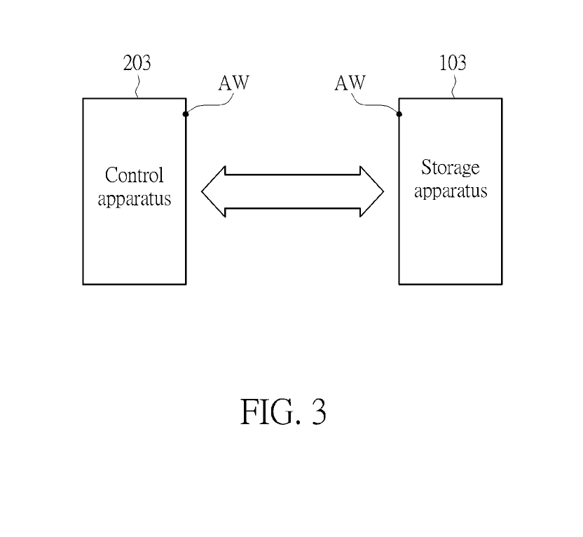

FIG. 3-5 are schematic diagrams illustrating methods for controlling the storage apparatus to exit the deep sleep mode and enter the normal mode according to one implementation of the present disclosure. In the implementation of FIG. 3, besides the clock port CLK, the data ports DATA and the data strobe port DQS, the control apparatus 101 and the storage apparatus 103 respectively comprises an awakening port AW. The control apparatus 101 applies the awakening port AW to transmit an awakening instruction AI to the storage apparatus 103, to control the storage apparatus 103 to exit the deep sleep mode and enter the normal mode. Since specific ports are assigned to transmit or receive the awakening instruction AI, almost all devices in the storage apparatus 103 can be non-active in the deep sleep mode, thus the power consumption and the leakage current for the storage apparatus 103 can be suppressed. Also, via this mechanism, it can be ensured the awakening instruction AI is successfully received by the storage apparatus 103 even if the storage apparatus 103 is in the deep sleep mode.

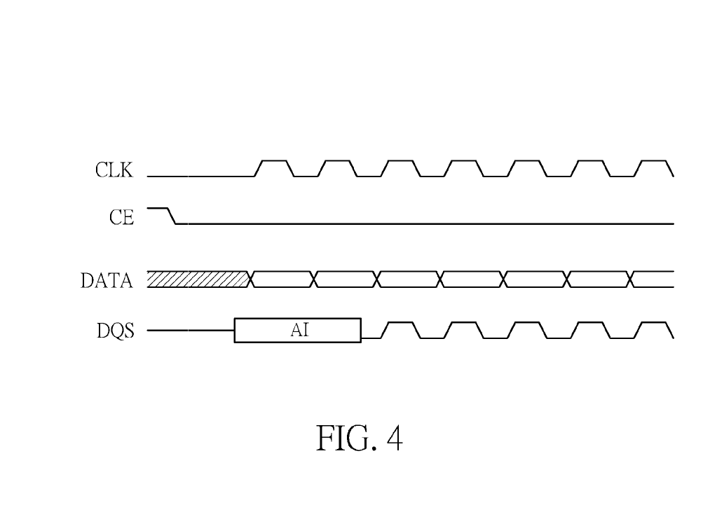

In the implementation of FIG. 4, the control apparatus 101 applies the data strobe port DQS to transmit an awakening instruction AI to the storage apparatus 103, to control the storage apparatus 103 to exit the deep sleep mode and enter the normal mode. In one implementation, the control apparatus 101 gives the storage apparatus 103 a enter instruction to enter the deep sleep mode, and uses an awakening instruction AI particularly corresponding to such instruction to exit the deep sleep mode and enter the normal mode.

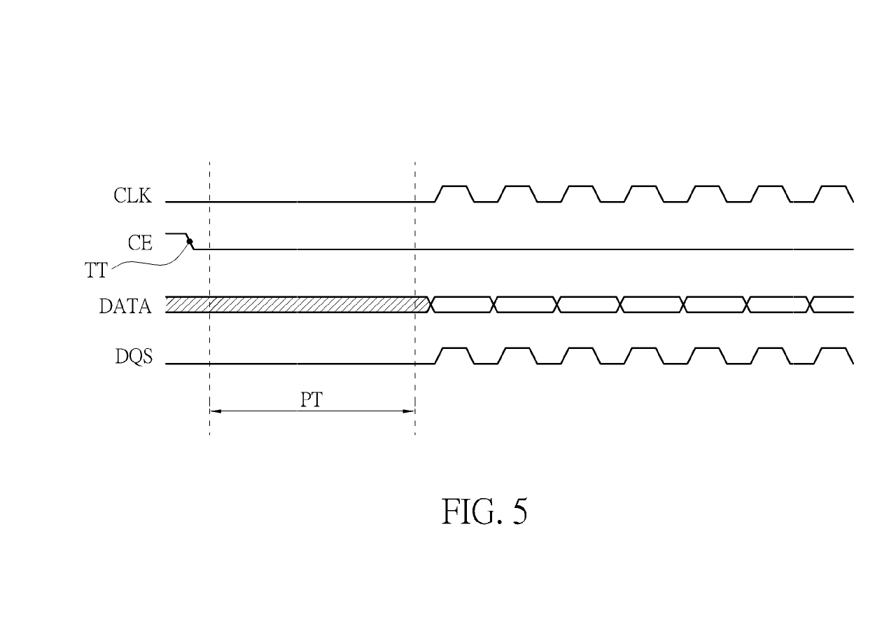

As above-mentioned, if the access indicating signal CE transits from the first logic value to the second logic value, it indicates at least one access operation will be performed to the storage apparatus 103. In the implementation of FIG. 5, the control apparatus 101 controls the storage apparatus 103 to exit the deep sleep mode and to enter the normal mode after a transiting timing TT for a predetermined time interval PT. The access indicating signal CE transits from the first logic value to the second logic value at the transiting timing TT. The predetermined time interval PT is larger or equals to the recovery time interval. By this way, it can be ensured that the accessing operations are performed after the recovery time interval (i.e. in the normal mode), thus can be normally performed. However, please note other mechanisms can be applied to indicate at least one access operation will be performed to the storage apparatus 103 as well. Therefore, the implementation illustrated in FIG. 4 can be summarized as: wherein the control apparatus 101 performs the accessing operation to the storage apparatus 103 after a transiting timing for a predetermined time interval, wherein a determining step indicates that at least one access operation will be performed to the storage apparatus at the transiting timing.

In another implementation, the control apparatus 101 transmits a dummy accessing command signal (in one implementation, a read command signal) to the storage apparatus 103 after the storage apparatus 103 exits the deep sleep mode. After that, the control apparatus 101 does not access the storage apparatus 103 until the control apparatus 101 receives a response corresponding to the dummy accessing command signal, wherein the response is generated by the storage apparatus 103. By this way, it can be ensured that the storage apparatus 103 is accessed in the normal mode, since the storage apparatus 103 cannot respond the dummy accessing command signal if does not normally operate in the normal mode.

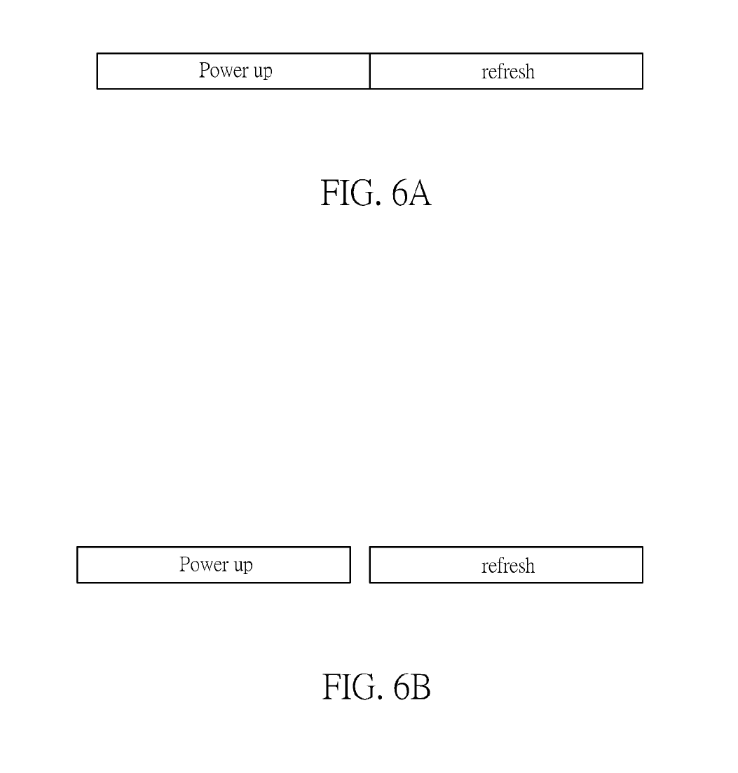

Additionally, if the storage apparatus 103 enters the deep sleep mode, the data stored therein may need to be periodic refreshed such that the data can be kept. Before each refresh operation, the storage apparatus 103 need to be powered up first (still in the deep sleep mode), and then the refresh operation is performed following the power up operation, as depicted in FIG. 6A.

However, if the storage apparatus receives the awakening instruction AI during the power up operation, the total wake up time interval (the time interval for leaving the deep sleep mode and to enter the normal mode) is extremely long since it includes power up time interval and refresh time interval. Accordingly, in one implementation, the power up operation and the fresh operation are separated, as depicted in FIG. 6B. In such case, if the storage apparatus 103 receives the awakening instruction AI during the power up operation, the storage apparatus exits the deep sleep mode and enters the normal mode after the power up operation and before the corresponding refresh rate operation, rather than conventionally perform the corresponding refresh operation after the power up operation.

In view of above-mentioned implementations, the storage apparatus can exit the deep sleep mode and enter the normal mode after the power up operation, even if receive the awakening instruction AI during the power up operation, thus the issue of long wake up time interval can be avoided.

Please note the above-mentioned control apparatus and the storage apparatus can be independently applied to other devices. Also, other methods for exiting the deep sleep mode besides the above-mentioned implementations can be applied if the storage apparatus enters the deep sleep mode. Accordingly, in view of above-mentioned implementations, a storage apparatus controlling method can be acquired, which comprises the step of: controlling a storage apparatus to enter a deep sleep mode and controlling the storage apparatus to exit the deep sleep mode and to enter a normal mode; wherein the storage apparatus keeps data stored therein in the deep sleep mode; wherein if the storage apparatus is controlled to enter a normal mode while in the deep sleep mode, the storage apparatus enters the normal mode after the storage apparatus exits the deep sleep mode for a recovery time interval , wherein the storage apparatus can be normally accessed in the normal mode. Such method can be performed by a control apparatus as above-mentioned, but can also be performed by other apparatuses. Other detail steps for the storage apparatus controlling method can be acquired based upon above-mentioned implementations, thus are omitted for brevity here.

In view of above-mentioned implementations, the storage apparatus can operate in a deep sleep mode that consumes less power and generates less leakage currents than a conventional standby mode. Further, methods for controlling the storage apparatus to exit the deep sleep mode and enter the normal mode can ensure that the storage apparatus can be correctly accessed.

Those skilled in the art will readily observe that numerous modifications and alterations of the device and method may be made while retaining the teachings of the invention. Accordingly, the above disclosure should be construed as limited only by the metes and bounds of the appended claims.

1. A storage apparatus controlling method, comprising:
(a) controlling a storage apparatus to enter a deep sleep mode, wherein the storage apparatus keeps data stored therein in the deep sleep mode; and
(b) controlling the storage apparatus to exit the deep sleep mode and to enter a normal mode, wherein the storage apparatus can be normally accessed in the normal mode;
wherein if the storage apparatus is controlled to enter the normal mode while in the deep sleep mode, the storage apparatus enters the normal mode after the storage apparatus exits the deep sleep mode for a recovery time interval.

2. The storage apparatus controlling method of claim 1, wherein the storage apparatus comprises a data port, a data strobe port and an awakening port, wherein the step (b) comprises:
applying the data port to receive data;
applying the data strobe port to receive or to transmit a data strobe signal; and
applying the awakening port to receive an awakening instruction, to control the storage apparatus to exit the deep sleep mode and enter the normal mode.

3. The storage apparatus controlling method of claim 1, wherein the storage apparatus comprises a data port and a data strobe port, wherein the step (b) comprises:
applying the data port to receive data;
applying the data strobe port to receive or to transmit a data strobe signal; and
applying the data strobe port to receive an awakening instruction, to control the storage apparatus to exit the deep sleep mode and enter the normal mode.

4. The storage apparatus controlling method of claim 1,
wherein the step (b) comprises performing the accessing operation to the storage apparatus after a transiting timing for a predetermined time interval, wherein a determining step indicates that at least one access operation will be performed to the storage apparatus at the transiting timing;
wherein the predetermined time interval is larger or equals to the recovery time interval.

5. The storage apparatus controlling method of claim 1,
wherein the step (b) comprises:
controlling the storage apparatus to receive a dummy accessing command signal after the storage apparatus exits the deep sleep mode; and
not accessing the storage apparatus until the storage apparatus generates a response corresponding to the dummy accessing command signal.

6. The storage apparatus controlling method of claim 1, further comprising:
controlling the storage apparatus to exit the deep sleep mode and enter the normal mode after a power up operation in the deep sleep mode and before a refresh operation corresponding to the power up operation, if the storage apparatus is controlled to exit the deep sleep mode and enter the normal mode during the power up operation.

7. A storage apparatus controlling method, applied to a control apparatus to control a storage apparatus, comprising:
(a) controlling a storage apparatus to enter a deep sleep mode via the control apparatus, wherein the storage apparatus keeps data stored therein in the deep sleep mode; and
(b) controlling the storage apparatus to exit the deep sleep mode and to enter a normal mode via the control apparatus, wherein the storage apparatus can be normally accessed in the normal mode;
wherein if the storage apparatus is controlled to enter the normal mode in the deep sleep mode, the storage apparatus enters the normal mode after the storage apparatus exits the deep sleep mode for a recovery time interval.

8. The storage apparatus controlling method of claim 7, wherein the control apparatus comprises a data port, a data strobe port and an awakening port, wherein the step (b) comprises:
applying the data port to transmit data to the storage apparatus;
applying the data strobe port to receive a data strobe signal from the storage apparatus or to transmit a data strobe signal to the storage apparatus; and
applying the awakening port to transmit an awakening instruction to the storage apparatus, to control the storage apparatus to exit the deep sleep mode and enter the normal mode.

9. The storage apparatus controlling method of claim 7, wherein the control apparatus comprises a data port and a data strobe port, wherein the step (b) comprises:
applying the data port to transmit data to the storage apparatus;
applying the data strobe port to receive a data strobe signal from the storage apparatus or to transmit a data strobe signal to the storage apparatus; and
applying the data strobe port to transmit an awakening instruction to the storage apparatus, to control the storage apparatus to exit the deep sleep mode and enter the normal mode.

10. The storage apparatus controlling method of claim 7, further comprising:
wherein the step (b) comprises performing at least one accessing operation to the storage apparatus after a transiting timing for a predetermined time interval, wherein a determining step indicates that at least one access operation will be performed to the storage apparatus at the transiting timing;
wherein the predetermined time interval is larger or equals to the recovery time interval.

11. The storage apparatus controlling method of claim 7,
wherein the step (b) comprises:
applying the control apparatus to transmit a dummy accessing command signal to the storage apparatus after the storage apparatus exits the deep sleep mode; and
not accessing the storage apparatus until the control apparatus receives a response corresponding to the dummy accessing command signal, wherein the response is generated by the storage apparatus.

12. The storage apparatus controlling method of claim 7, further comprising:
controlling the storage apparatus to exit the deep sleep mode and enter the normal mode after a power up operation in the deep sleep mode and before a refresh operation corresponding to the power up operation, if the storage apparatus is controlled to exit the deep sleep mode and enter the normal mode during the power up operation.

13. A storage apparatus, configured to receive an enter instruction to enter a deep sleep mode and configured to receive an awaking instruction to exit the deep sleep mode and to enter a normal mode;
wherein the storage apparatus keeps data stored therein in the deep sleep mode, wherein the storage apparatus can be normally accessed in the normal mode;
wherein if the storage apparatus is controlled to enter the normal mode while in the deep sleep mode, the storage apparatus enters the normal mode after the storage apparatus exits the deep sleep mode for a recovery time interval.

14. The storage apparatus of claim 13, wherein the storage apparatus comprises a data port for receiving data, a data strobe port for receiving or transmitting a data strobe signal and an awakening port, wherein the storage apparatus applies the awakening port to receive an awakening instruction to accordingly exit the deep sleep mode and enter the normal mode.

15. The storage apparatus of claim 13, wherein the storage apparatus comprises a data port for receiving data, a data strobe port for receiving or transmitting a data strobe signal, wherein the storage apparatus applies the data strobe port to receive an awakening instruction, to accordingly control the storage apparatus to exit the deep sleep mode and enter the normal mode.

16. The storage apparatus of claim 13,
wherein the storage apparatus transmits or receives data after a transiting timing for a predetermined time interval, wherein a determining step indicates that at least one access operation will be performed to the storage apparatus at the transiting timing;
wherein the predetermined time interval is larger or equals to the recovery time interval.

17. The storage apparatus of claim 13, wherein the storage apparatus receives a dummy accessing command signal after the storage apparatus exits the deep sleep mode, and the storage apparatus does not receive or transmit data until the storage apparatus generates a response corresponding to the dummy accessing command signal.

18. The storage apparatus of claim 13, wherein the storage apparatus exits the deep sleep mode and enters the normal mode after a power up operation in the deep sleep mode and before a refresh operation corresponding to the power up operation, if the storage apparatus is controlled to exit the deep sleep mode and enter the normal mode during the power up operation.

19. A storage system, comprising:
a storage apparatus; and
a control apparatus, configured to control a storage apparatus to enter a deep sleep mode via the control apparatus, and configured to control the storage apparatus to exit the deep sleep mode and to enter a normal mode;
wherein the storage apparatus keeps data stored therein in the deep sleep mode, wherein the storage apparatus can be normally accessed in the normal mode;
wherein if the storage apparatus is controlled to enter the normal mode in the deep sleep mode, the control apparatus controls the storage apparatus to enter the normal mode after the storage apparatus exits the deep sleep mode for a recovery time interval.

20. The storage system of claim 19, wherein the control apparatus comprises a data port configured to transmit data to the storage apparatus, a data strobe port configured to receive a data strobe signal from the storage apparatus or configured to transmit a data strobe signal to the storage apparatus, and an awakening port to transmit an awakening instruction to the storage apparatus, to control the storage apparatus to exit the deep sleep mode and enter the normal mode.

21. The storage system of claim 19, wherein the control apparatus comprises a data port for transmitting data to the storage apparatus, a data strobe port configured to receive a data strobe signal from the storage apparatus or configured to transmit a data strobe signal to the storage apparatus, wherein the control apparatus applies the data strobe port to transmit an awakening instruction to the storage apparatus, to control the storage apparatus to exit the deep sleep mode and enter the normal mode.

22. The storage system of claim 19,
wherein the control apparatus performs at least one accessing operation to the storage apparatus to enter the normal mode after a transiting timing for a predetermined time interval, wherein a determining step indicates that at least one access operation will be performed to the storage apparatus at the transiting timing;
wherein the predetermined time interval is larger or equals to the recovery time interval.

23. The storage system of claim 19, wherein the control apparatus transmits a dummy accessing command signal to the storage apparatus after the storage apparatus exits the deep sleep mode, and the control apparatus does not access the storage apparatus until the control apparatus receives a response corresponding to the dummy accessing command signal, wherein the response is generated by the storage apparatus.

24. The storage system of claim 19, wherein control apparatus controls the storage apparatus to exit the deep sleep mode and to enter the normal mode after a power up operation in the deep sleep mode and before a refresh operation corresponding to the power up operation, if the storage apparatus is controlled to exit the deep sleep mode and enter the normal mode during the power up operation.
